(19) United States
(12) Patent Application Publication
(10) Pub. No.: US 2024/0345880 A1
(43) Pub. Date: Oct. 17, 2024

(54) RESOURCE MANAGEMENT USING FLEXIBLY-SCHEDULED PROCESSING

(71) Applicant: The Toronto-Dominion Bank, Toronto (CA)

(72) Inventors: David Samuel TAX, Toronto (CA); Milos DUNJIC, Oakville (CA); Vipul Kishore LALKA, Oakville (CA); Jonathan Joseph PRENDERGAST, West Chester, PA (US); Hitesh BAJAJ, Duluth, GA (US); Susan Elizabeth HAWKINS, Olga, WA (US)

(73) Assignee: The Toronto-Dominion Bank, Toronto, ON (CA)

(21) Appl. No.: 18/298,632

(22) Filed: Apr. 11, 2023

(51) Int. Cl. G06F 9/48; G06F 9/50

(52) U.S. Cl. CPC G06F 9/4887; G06F 9/5027

(57) ABSTRACT

Methods and systems for controlling computing processes to manage finite resources are described. In an aspect, a method may include obtaining resource availability data indicating current resource availability for a resource associated with the computing system. The method may further include detecting an excess availability of a resource of a particular type based on the resource availability data. The method may further include, in response to detecting the excess availability of the resource of the particular type, identify a flexibly-scheduled computing process requiring the use of the resource of the particular type. The method may further include initiating the flexibly-scheduled computing process to consume at least a portion of the excess availability of the resource.

### TECHNICAL FIELD

The present application relates to resource management at a computing system and, more particularly, to systems and methods for controlling executing computing processes to manage available resources.

### BACKGROUND

Computing systems perform various computing processes. Such computing processes may include, for example, any one or more of: executing an application, sending data to and receiving data from other computing systems, performing database operations, etc.

Often, computing processes are performed in a manner that inefficiently utilizes resources. For example, computing processes may be performed immediately upon request which may result in situations in which resources become limited. For example, a number of computing processes that all require the use of a particular resource may all be performed at a common time and this may cause a temporary shortage of the resource. This may result in overload conditions which may, for example, slow execution of one or more of the computing processes and, in some instances, may slow operation of the computing system more generally.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified schematic diagram showing components of a computing device;

FIG. 3 is a high-level schematic diagram of an example computer device;

FIG. 4 shows a simplified organization of software components stored in a memory of the example computer device of FIG. 3;

FIG. 5 is a flowchart showing operations performed by a computing system in initiating a computing process;

FIG. 6 is an example interface in accordance with an example embodiment;

FIG. 7 is an example computing process queue in accordance with an example embodiment;

FIG. 8 illustrates example resource availability data in accordance with an example embodiment;

FIG. 9 is a flowchart showing operations performed by a computing system in initiating a computing process; and

FIG. 10 is an example computing process queue in accordance with an example embodiment.

Like reference numerals are used in the drawings to denote like elements and features.

### DETAILED DESCRIPTION OF VARIOUS EMBODIMENTS

In an aspect, a processor-implemented method is disclosed. The method may be performed by a computing system. A method may include: obtaining resource availability data indicating current resource availability for a resource associated with the computing system; detecting an excess availability of a resource of a particular type based on the resource availability data; in response to detecting the excess availability of the resource of the particular type, identifying a flexibly-scheduled computing process requiring the use of the resource of the particular type; and initiating the flexibly-scheduled computing process to consume at least a portion of the excess availability of the resource.

In some implementations, identifying a flexibly-scheduled process includes identifying computing processes that are designated as having a variable time parameter while ignoring computing processes that are identified as having a rigid time parameter.

In some implementations, the flexibly-scheduled computing process may be associated with a time parameter identifying a last time at which the flexibly-scheduled computing process is to be performed. A computing process that is identified as having a rigid time parameter may be a computing process that is to be completed at a defined time. In some implementations, the defined time may be a current time.

In some implementations, the computing process may include a database management operation.

In some implementations, the computing process may include a transfer of at least a portion of the resource.

In some implementations, the method may further include: identifying recurring computing processes associated with a particular logical storage area, the recurring computing processes utilizing a particular non-native resource; and in response to identifying the recurring computing processes utilizing the particular non-native resource, sending a data package to an endpoint associated with the particular logical storage area, the data package including data to enable the endpoint to cause future computing processes involving the non-native resource and associated with the particular logical storage area to be designated as flexibly-scheduled by default.

In some implementations, the data package may indicate a modifier to be used for flexibly-scheduled computing processes that is not used for computing processes having a rigid time parameter. Initiating the flexibly-scheduled computing process may include using the modifier.

In some implementations, identifying the flexibly-scheduled computing process may include: identifying a set of flexibly-scheduled computing processes requiring the use of the resource of the particular type; and selecting one of the flexibly-scheduled computing processes from the identified set as the identified flexibly-scheduled computing process based on a proximity of a time parameter identifying a last time at which the flexibly scheduled computing process is to be performed to a current time.

In some implementations, the data package may indicate a modifier to be used for flexibly-scheduled computing processes that is not used for computing processes having a rigid time parameter. Initiating the flexibly-scheduled computing process may include using the modifier.

In some implementations, identifying the flexibly-scheduled computing process may include: identifying a set of flexibly-scheduled computing processes requiring the use of the resource of the particular type; and selecting one of the flexibly-scheduled computing processes from the identified set as the identified flexibly-scheduled computing process based on a proximity of a time parameter identifying a last time at which the flexibly scheduled computing process is to be performed to a current time.

In some implementations, detecting an excess availability of a resource of a particular type based on the resource availability data may include detecting another computing process whose execution causes the excess availability of the resource of the particular type.

In some implementations, the another computing process may be a transfer providing an excess supply of a non-native resource.

In another aspect, a computing system is described. The computing system may include a communications module. The computing system may include a processor coupled with the communications module. The computing system may include a memory coupled to the processor and storing processor-executable instructions which, when executed by the processor, configure the computing system to perform a method described herein. For example, the instructions may configure the computing system to: obtain resource availability data indicating current resource availability for a resource associated with the computing system; detect an excess availability of a resource of a particular type based on the resource availability data; in response to detecting the excess availability of the resource of the particular type, identify a flexibly-scheduled computing process requiring the use of the resource of the particular type; and initiate the flexibly-scheduled computing process to consume at least a portion of the excess availability of the resource.

In another aspect, a computer-readable storage medium may be provided. The computer-readable storage medium may include processor-executable instructions which, when executed, configure a processor to perform a method described herein.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Example embodiments of the present application are not limited to any particular operating system, system architecture, mobile device architecture, computing system architecture, or computer programming language.

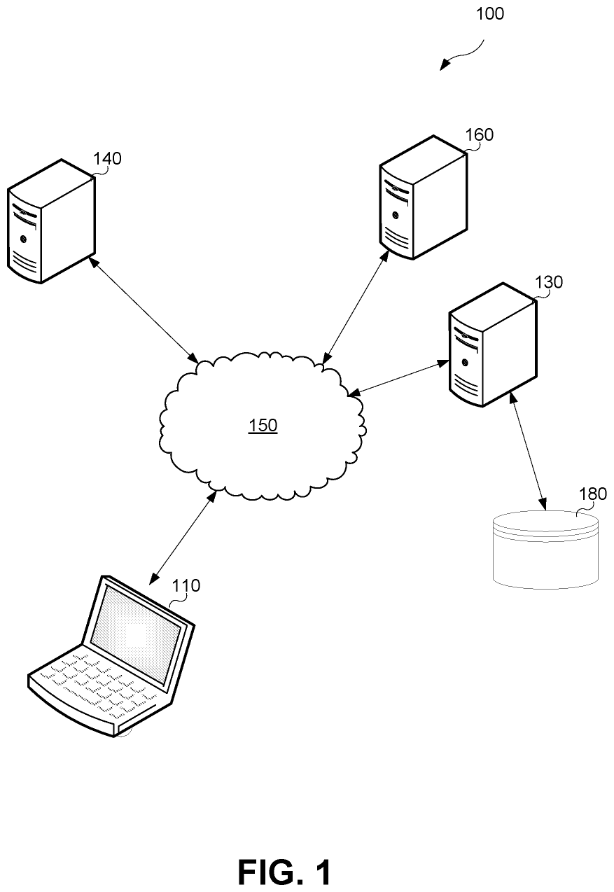

FIG. 1 is a block diagram illustrating an operating environment of an example embodiment. Various components cooperate to provide a system 100 which may be used, for example, to perform an operation such as performing, initiating or executing a computing process. The computing process may be of a variety of types. For example, in some implementations, the computing process may be or include a database management operation. For example, the computing process may include an update to logical storage area such as a record in a database. In some implementations, the computing process may be or include a transfer operation. A transfer operation, which may also be referred to as a transfer, may be an operation in which a transfer of data is performed. A transfer may be or represent, for example, a transfer of resources represented by one record in a database to another record in that database or in another database. In some implementations, the computing process may include any one or more of: a read operation, a write operation, a send operation, a receive operation, a database update operation, a database management operation, a transfer operation, a payment operation, a data retrieval operation, a data storage operation, or an operation of another type.

A particular computing process may, during execution, use or consume resources. The nature of resources that are used or consumed will depend upon the nature of the computing process.

Some computing processes may use a large amount of storage resources, such as memory that is used for long-term storage, including for example non-transitory storage such as space in a hard disk drive (HDD), solid state disk drive (SSDD), etc. Some computing processes may consume a large amount of transient memory such as random access memory (RAM). Some computing processes may consume a large amount of processor cycles. Some computing processes may consume a large amount of network resources, such as bandwidth. Some computing processes may consume a large amount of particular units of value storage resources including, for example, non-native resources. Non-native resources are resources that are not native to a particular computing system, such as a computing system that is initiating the computing process. By way of example, non-native resources may be or represent resources that are not available on a first computing system but that are available and can be accessed from a second computing system. For example, the non-native resources may be or represent a foreign transfer medium or a non-native transfer medium such as a foreign medium of exchange or foreign resource. The foreign medium of exchange or foreign resource may be, for example, a data compression algorithm not native to the computing system initiating the computing process, a codec not native to the computing system initiating the computing process, or a foreign currency or exchange medium not considered native by the computing system initiating the computing process.

As will be described below, the system 100 may manage the executing and initiation of computing processes such that certain computing processes may be flexibly-scheduled so that they are performed when excess resources that are required for such processes are determined to be available. In at least some implementations, flexibly-scheduled computing processes may have a time parameter, such as a due date or deadline. If the computing process has not been executed or initiated prior to the due date or deadline (or within a predefined proximity to such a due date or deadline), then the flexibly-scheduled computing process may be converted to a non-flexibly scheduled computing process so that it is initiated even if excess resources are not available. Conveniently, in this way, resources may be used or consumed in an efficient manner without risk that certain computing processes may remain unperformed indefinitely.

As shown, the system 100 includes an endpoint 110, a first computing system 130 and a second computing system 140 coupled to one another through a network 150, which may include a public network such as the Internet and/or a private network. The endpoint 110 may be client device such as a computing device that may be associated with an entity, such as a user or client, having a logical storage area such as record in a database associated with and/or provided by the first computing system 130. The record may be or represent account data. The endpoint 110 may also, in some implementations, be referred to as an electronic device. The logical storage area, such as the record, may include data of various types and the nature of the data will depend on the nature of the first computing system 130.

By way of example, in some implementations, the first computing system 130 may maintain user accounts and logical storage area such as a record in the database may be or represent an account. The record may include, for example, documents and/or other data stored by or on behalf of a user. By way of example, in an implementation, a user account may include documents or data uploaded by the user. Such documents and/or data may include, for example, any one or more of: images such as photographs, text-based documents, documents prepared according to a standardized file format, such as portable document format (PDF) documents, user preferences, digital identity data such as stored identity information or documentation, or other types of documents and/or data. For example, in an implementation, the first computing system may track, manage, maintain, and/or provide resources to the entity. The resources may, for example, be computing resources, such as memory or processor cycles. By way of further example, the resources may include stored value, such as fiat currency, which may be represented in a database. For example, the first computing system 130 may be coupled to a database 180, which may be provided in secure storage. The secure storage may be provided internally within the first computing system 130 or externally. The secure storage may, for example, be provided remotely from the first computing system 130. For example, the secure storage may include one or more data centers. The data centers may, for example, store data with bank-grade security.

The database 180 may include records associated with a plurality of entities. For example, the records may be for a plurality of accounts and at least some of the records may define or store resources. For example, the records may define a quantity of resources. For example, the entity that is associated with the endpoint 110 may be associated with an account having one or more records in the database. The records may reflect a quantity of stored resources that are associated with the entity. Such resources may include owned resources and, in at least some embodiments, borrowed resources. The resources that are associated with an entity may be grouped into various buckets. Some such buckets may, for example, represent individual bank accounts. For example, an entity may be associated with one or more bank accounts. At least some of the resources may be borrowed resources. The borrowed resources may, for example, represent an amount of credit that is available to the entity. The entity that is associated with the endpoint 110 and the account may be a customer of a financial institution which operates or manages the first computing system 130.

The first computing system 130 may have access to other data such as, for example, a computing process queue and/or resource availability data and/or historical computing process data. Such data may be stored in the database 180 or in another storage system and/or may be accessed from another resource associated with the first computing system 130 such as, for example, a processor which may provide read-time resource availability data.

The resource availability data may indicate a current availability for a resource. For example, the resource availability data may indicate a current availability of a particular resource. The particular resource may be of a type described above. For example, the particular resource may be or include one or more of: storage non-transitory storage resources and transient memory resources, processor cycles, network resources, such as bandwidth, units of value storage resources including, for example, non-native resources, a foreign transfer medium or a non-native transfer medium such as a foreign medium of exchange or foreign resource or a resource of another type. By way of example, in one example, resource availability data may indicate an amount of non-native units of a particular type that are accessible to or associated with the first computing system 130. The resource availability data may indicate an amount of resources available for a number of types of resources. For example, it may indicate an amount of resources currently available for a first type of resource and an amount of resources currently available for a second type of resource. By way of example, the first type of resource may be a first non-native resource and the second type of resource may be a second non-native resource.

The computing process queue may be a record or list of computing processes that are to be performed. The computing processes may be or include, for example, one or more flexibly-scheduled computing processes. The computing processes may also be or include one or more non-flexibly-scheduled computing processes. Non-flexibly-scheduled computing processes may be or include computing processes that are identified as having a rigid time parameter. For example, a rigid time parameter may be a time parameter that requires the computing process to be initiated or completed at a defined time. In some implementations, the defined time may be a current time so that the non-flexibly-scheduled computing process is to be completed immediately.

Flexibly-scheduled computing processes may, in at least some implementations, be associated with a time parameter that is less rigid than the rigid time parameter associated with non-flexibly-scheduled computing processes. For example, a flexibly-scheduled computing process may be associated with a due date or deadline. Put differently, a flexibly-scheduled computing process may be associated with a time parameter identifying a last time at which the flexibly-scheduled computing process is to be performed.

In at least some implementations, the computing process queue may indicate which of the computing processes are flexibly-scheduled and which are non-flexibly-scheduled. Additionally or alternatively, the computing process queue may associate one or more of the computing processes with a type of resource that is required for performance of that computing process. For example, a first computing process may be associated with a first resource to indicate that the first computing process requires the first resource and a second computing process may be associated with a second resource to indicate that the second computing process requires the second resource. Some computing processes may require more than one resource in order to be performed and, in at least some implementations, each such resource may be indicated. In other implementations, each computing process may be associated with only one resource in the computing process queue. For example, where more than one resource is required, a certain type of resource may be selected as a primary resource. The primary resource may be a resource that is a most-scarce resource of all resources required, for example. The primary resource may be selected in other ways.

As noted above, the first computing system 130 may have access to historical computing process data. Such data may, in some implementations, be stored in or associated with records in the database 180. The historical computing process data may be or include historical transfer data. The historical computing process data may indicate past computing processes that have been performed in association with a particular logical storage area. The historical computing process data may indicate a particular resource associated with one or more of the past computing processes. For example, the historical computing process data may indicate a particular non-native resource used in one or more of the historical computing processes represented by the historical computing process data.

The first computing system 130 and the second computing system 140 may be operated by different entities. That is, the first computing system 130 may be associated with a first system operator and the second computing system 140 may be associated with a second system operator who is different than the first system operator. The second computing system 140 may be, for example, associated with a financial institution computing system that is associated with a different financial institution than a first computing system 130 and may maintain customer financial accounts. That is, the second computing system 140 may maintain a database that includes various data records. A data record may, for example, reflect an amount of value stored in a particular account associated with a user.

While not illustrated in FIG. 1, the second computing system 140 may include or be connected with a database that operates similar to the database 180 that provided by or associated with the first computing system 130.

The endpoint 110 may take a variety of forms such as a smartphone, a tablet computer, a wearable computer such as a head-mounted display or smartwatch, a laptop or desktop computer, or a computing device of another type. The first computing system 130 and/or the second computing system 140 may be referred to as first and second computing devices respectively and the endpoint 110 may be referred to as a third computing device. In certain embodiments, the endpoint 110 may be adapted to present a graphical user interface that allows for communication with the first computing system 130.

The network 150 is a computer network. In some embodiments, the network 150 may be an internetwork such as may be formed of one or more interconnected computer networks. For example, the network 150 may be or may include an Ethernet network, an asynchronous transfer mode (ATM) network, a wireless network, a telecommunications network, or the like.

The first computing system 130 may be configured to communicate with other computing systems, such as the second computing system 140 using one or more communication protocols, which may also be referred to as transfer protocols or transfer rails. The speed of the transfer protocols supported by the computing systems may vary. For example, at least one transfer protocol that is supported by the first computing system 130 may be a real time transfer protocol and at least one transfer protocol that is supported by the first computing system 130 may be a non-real time transfer protocol. The non-real time transfer protocol may, in at least some implementations, take more than one hour to complete a transfer. In some implementations, the non-real time transfer protocol may take twenty-four (24) hours or more to complete the transfer.

Some computing systems may not support some transfer protocols. For example, a third computing system (not shown) may not support the real time transfer protocol while the second computing system 140 may support the real time transfer protocol. In another implementation, the second computing system 140 may not support the real time transfer protocol but the third computing system may support the real time transfer protocol.

The real time transfer protocol may allow a transfer to be completed in real time or near real time. For example, a transfer may be completed in twenty seconds or less in at least some implementations. In some implementations, a transfer may be completed in five (5) seconds or less.

One or more of the transfer protocols supported by the first computing system 130 may, in at least some implementations, operate through a third-party computing system 160.

In at least some embodiments, a third-party computing system 160 may be a transfer rail computing system configured to facilitate a transfer from a first data record to a second data record according to a first transfer protocol. The first data record may be a data record maintained by the first computing system 130 and the second data record may be a data record maintained by a computing system associated with a different system operator than the first computing system 130 (e.g., such as the second computing system 140). The transfer rail computing system may be a real-time transfer rail computing system and may be configured to process the transfer in real-time or near real-time. The transfer rail computing system may operate as an intermediary between the first computing system 130 and the second computing system 140. In some implementations, the third-party computing system 160 may be or include a conversion agent system which facilitates a conversion of resources. By way of example, the conversion agent system may include one or more of a codec server, a data compression server, a correspondent banking server, a foreign-exchange server, or a server of another type.

While not depicted in FIG. 1, in at least some implementations, the system 100 includes a further third-party computing system which acts as a further transfer rail computing system. The further third-party computing system may facilitate transfers between the first computing system 130 and the second computing system 140 according to a second transfer protocol. The second transfer protocol may be a non-real time transfer protocol.

One or more of the transfer protocols may not require the use of a third-party computing system. For example, one or more of the transfer protocols may operate through the exchange of messages directly between the first computing system 130 and the second computing system 140. Such messages may be exchanged through the network 150.

In at least some implementations, the first computing system 130 may initiate a transfer of a non-native resource to the second computing system 140 and the non-native resource may be a resource that is not native to the first computing system 130 but that is native to the second computing system 140. For example, the transfer may be a transfer of a foreign units of exchange such as a foreign currency (i.e., a currency that is not the native currency of the first computing system 130 but that is the native currency of the second computing system 140).

The endpoint 110, the first computing system 130, the second computing system 140 and the third-party computing system 160 may be in geographically disparate locations. Put differently, the endpoint 110, the first computing system 130, the second computing system 140, and the third-party computing system 160 may be remote from one another.

The first computing system 130 may also be referred to as a first system or a first database management system. The second computing system 140 may also be referred to as a second system or a second database management system.

FIG. 1 illustrates an example representation of components of the system 100. The system 100 can, however, be implemented differently than the example of FIG. 1. For example, various components that are illustrated as separate systems in FIG. 1 may be implemented on a common system. By way of further example, the functions of a single component may be divided into multiple components.

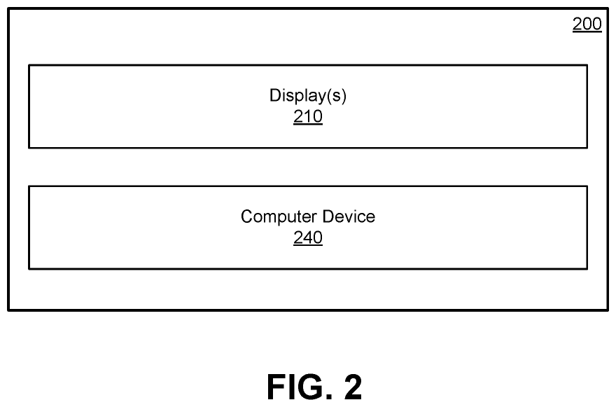

FIG. 2 is a simplified schematic diagram showing components of an exemplary computing device 200. The endpoint 110 may be of the same type as computing device 200. The computing device 200 may include modules including, as illustrated, for example, one or more displays 210 and a computer device 240.

The one or more displays 210 are a display module. The one or more displays 210 are used to display screens of a graphical user interface that may be used, for example, to communicate with the first computing system 130 (FIG. 1). The one or more displays 210 may be internal displays of the computing device 200 (e.g., disposed within a body of the computing device).

The computer device 240 is in communication with the one or more displays 210. The computer device 240 may be or may include a processor which is coupled to the one or more displays 210.

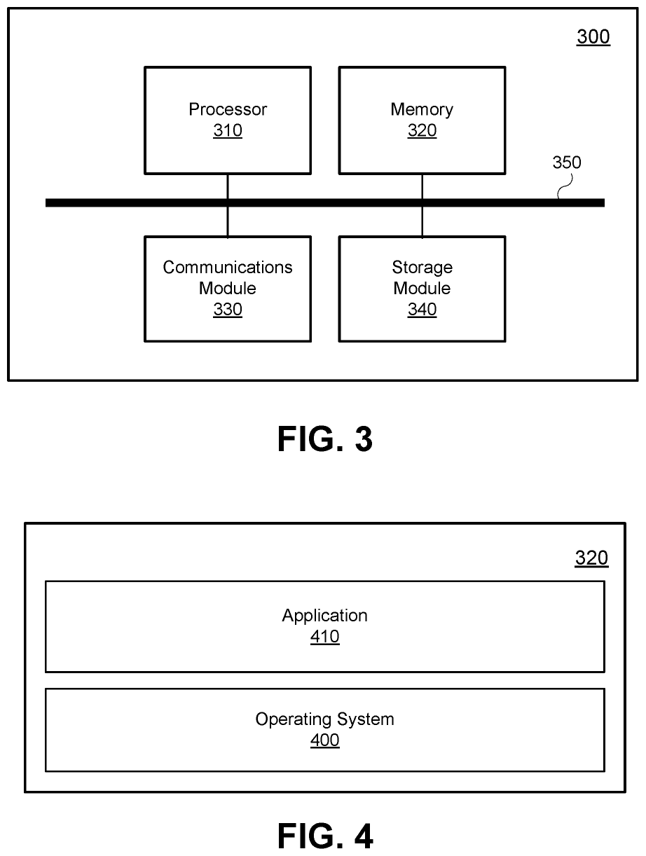

Referring now to FIG. 3, a high-level operation diagram of an example computer device 300 is shown. In some embodiments, the computer device 300 may be exemplary of the computer device 240 (FIG. 2), the first computing system 130, the endpoint 110, the second computing system 140 and/or the third-party computing system 160.

The example computer device 300 includes a variety of modules. For example, as illustrated, the example computer device 300 may include a processor 310, a memory 320, a communications module 330, and/or a storage module 340. As illustrated, the foregoing example modules of the example computer device 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computer device 300.

The communications module 330 allows the example computer device 300 to communicate with other computer or computing devices and/or various communications networks. For example, the communications module 330 may allow the example computer device 300 to send or receive communications signals. Communications signals may be sent or received according to one or more protocols or according to one or more standards. For example, the communications module 330 may allow the example computer device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computer device 300 to communicate using near-field communication (NFC), via Wi-Fi™, using Bluetooth™ or via some combination of one or more networks or protocols. In some embodiments, all or a portion of the communications module 330 may be integrated into a component of the example computer device 300. For example, the communications module may be integrated into a communications chipset. In some embodiments, the communications module 330 may be omitted such as, for example, if sending and receiving communications is not required in a particular application.

The storage module 340 allows the example computer device 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the processor 310 in concert with the communications module 330 such as, for example, if data is stored remotely. The storage module may also be referred to as a data store.

Where the example computer device 300 functions as the first computing system 130 of FIG. 1, the storage module 340 may allow the example computing device 300 to access the secure data in the database 180.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the example computer device 300 (FIG. 3). As illustrated, these software components include an operating system 400 and an application 410.

The operating system 400 is software. The operating system 400 allows the application 410 to access the processor 310 (FIG. 3), the memory 320, and the communications module 330 of the example computer device 300 (FIG. 3). The operating system 400 may be, for example, Google™ Android™, Apple™ iOS™, UNIX™, Linux™, Microsoft™ Windows™, Apple OSX™ or the like.

The application 410 adapts the example computer device 300, in combination with the operating system 400, to operate as a device performing a particular function. For example, the application 410 may cooperate with the operating system 400 to adapt a suitable embodiment of the example computer device 300 to operate as the computer device 240 (FIG. 2), the first computing system 130, the endpoint 110, the third-party computing system 160 and/or the second computing system 140.

While a single application 410 is illustrated in FIG. 3, in operation the memory 320 may include more than one application 410 and different applications 410 may perform different operations. For example, in at least some embodiments in which the computer device 300 is functioning as the endpoint 110, the applications 410 may include a transfer management application. The transfer management application may be configured for secure communications with the first computing system 130 and may provide various functions such as, for example, the ability to display data in a record in the database 180. In some implementations, the transfer management application may be a banking application which may, for example, be configured to display a quantum of value in one or more data records (e.g. display balances), configure or request that operations such as transfers of value (e.g. bill payments, wire payment, email money transfers and other transfers) be performed, and perform other account management functions.

By way of further example, in at least some embodiments in which the computer device 300 functions as the endpoint 110, the applications 410 may include a web browser, which may also be referred to as an Internet browser. In at least some such embodiments, the first computing system 130 may be or include a web computing system that may serve one or more of the interfaces described herein. The web computing system may cooperate with the web browser and may serve as an interface when the interface is requested through the web browser. For example, the web browser may serve as a mobile banking interface. The mobile banking interface may provide various banking functions such as, for example, the ability to display a quantum of value in one or more data records (e.g. display balances), configure or request that operations such as transfers of value (e.g. bill payments and other transfers) be performed, and other account management functions.

The first computing system 130 may be configured to receive and complete data transfer requests and other computer processes. A transfer may be a transfer of resources such as, for example, documents, tokens, computing resources and other stores of value. In some examples, a transfer may be a transfer of value or other resources from a first account to a second account. The first computing system 130 is configured to complete received data transfer requests according to one or more transfer methods (which may also be referred to herein as transfer protocols). For example, a first transfer method may utilize a real-time transfer rail computing system configured to process the transfer in a first transfer time which may be real-time or near real-time. A second transfer method may utilize a transfer rail computing system configured to process the transfer in a second transfer time that is longer than the first transfer time. Additional transfer methods may also be used.

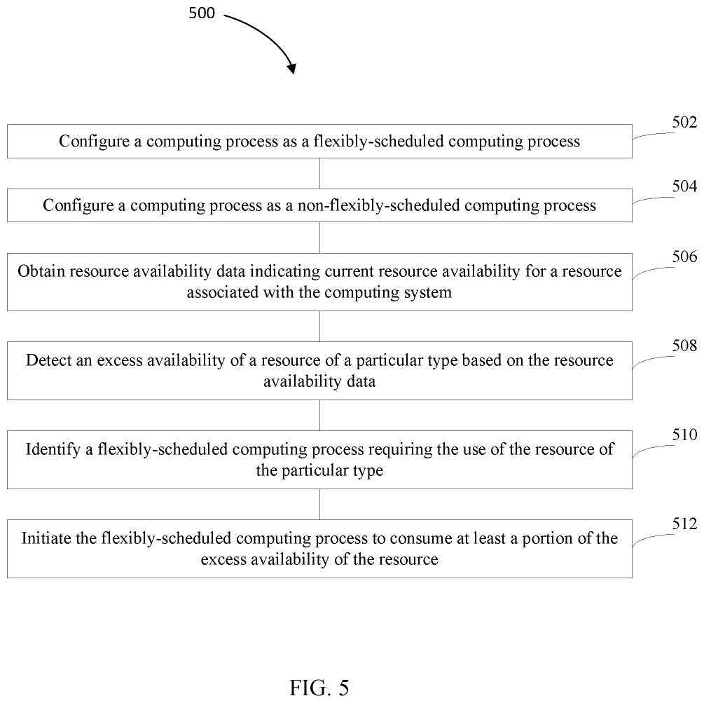

Reference will now be made to FIG. 5, which illustrates a flowchart of an example method 500. FIG. 5 shows operations performed by a computing system, such as the first computing system 130. For example, in at least some implementations, computer-executable instructions stored in memory associated with the computing system may configure the computing system to perform the operations of the method 500 or a portion thereof. By way of example, the computer-executable instructions may cause a processor associated with the computing system to perform the method 500 or a portion of the method 500.

The computing system performing the method 500 may cooperate with other computing systems using a communications module. The communications module may be or include a hardware communications module. By way of example, the first computing system 130 may communicate with one or more of a second computing system 140, and an endpoint 110 in order to perform the method 500 or a variation thereof.

At an operation 502, the method 500 includes configuring a computing process as a flexibly-scheduled process and, at an operation 504, configuring another computing process as a non-flexibly-scheduled process. Put differently, some computing processes may be configured, by the computing system, as flexibly-scheduled while other computing processes may be configured as non-flexibly-scheduled.

The computing processes may be configured as either flexibly-scheduled or not-flexibly-scheduled based on configuration data associated with such computing processes. The configuration data for a particular computing process may be defined by an endpoint 110 that is associated with that computing process. For example, one or more of the computing processes may be associated with one or more logical storage areas that may be or represent an account and that computing process may, in this way, be associated with that account. For example, one or more of the computing processes may include transfers of resources associated with the account. The transfers may be transfers of non-native resources. For example, the transfers may include a transfer that negatively adjusts a value representing a balance in an account and the value may be determined based on a modifier such as a conversion rate. The endpoint 110 that is associated with an account that is associated with a particular computing process may define whether that computing process is to be flexibly-scheduled or non-flexibly-scheduled. The configuration data may, additionally or alternatively, configure whether other types of computing processes, apart from data transfers, are flexibly-scheduled or rigidly scheduled.

The computing processes may be configured or defined in a computing process queue. The computing process queue may track incomplete computing processes; that is, computing processes that have yet to be completed. The computing process queue may track only specific types of computing processes in at least some implementations, such as, for example, transfers involving a non-native resource. The computing process queue may indicate configuration data or parameters associated with pending computing processes. For example, a computing process in the computing process queue may be associated with data indicating a resource type that is required for completion of that computing process and/or scheduling data for that computing process. The resource type may be, for example, a type of the primary resource required for completion of the computing process. The scheduling data may indicate whether the computing process is a flexibly-scheduled computing process and/or whether it is a non-flexibly-scheduled computing process. Put differently, the scheduling data may indicate whether the associated computing process may be completed at a time determined by the computing system performing the method 500 to be convenient or whether it is to be completed at a fixed time, in which case it may be said to have a rigid time parameter. In at least some implementations, a rigid time parameter that is associated with a non-flexibly-scheduled computing process specifies that the computing process is to be completed at a defined time. The defined time may be, for example, the current time. That is, the computing process queue may indicate that some computing processes are to be completed immediately or as soon as possible. The configuration data or parameters for a particular computing process in the queue may be defined based on input received from an endpoint 110 that configured the computing process or that caused the computing process to be initiated.

At an operation 506, the computing system performing the method 500 may obtain resource availability data indicating current resource availability for a resource associated with the computing system. The resource may, for example, be a computing resource, such as memory or processor cycles. By way of further example, the resource may be a database resource or data. The computing system may determine the current resource availability for a resource that is required to complete a computing process such as a computing process configured at the operation 502 or a computing process configured at the operation 504.

The computing system may determine the current resource availability using various techniques and the technique used may depend on the nature of the resource. For example, the current resource availability may be determined through a call to a processor and/or memory. In some implementations, the current resource availability may be determined through a database query. By way of example, the current resource availability may be determined by requesting resource availability data from a memory such as, for example, a database that stores resource availability data for various types of resources. In at least some implementations, the current availability of resources may be determined by a call to another computing system such as, for example, a third-party computing system 160.

Next, at an operation 508, the computing system performing the method 500 may detect an excess availability of a resource of a particular type based on the resource availability data. The particular type may be a type of resource that is required to complete processing of a computing process configured at the operation 502 as a flexibly-scheduled computing process. For example, the computing system performing the method 500 may, at the operation 508, detect that there is an excess availability of a resource of that is required to complete the computing process configured at the operation 502. The particular type may be a non-native resource.

An excess availability of a resource may be detected based on a threshold. The threshold may, for example, be defined based on a typical level of resources available. For example, when the current resource availability for a particular resource exceeds the threshold, then it may be determined that there is an excess availability of the resource.

In at least some implementations, when determining that there is an excess availability of a particular type of resource, the system may ensure that resources of the particular type remain available even after all computing processes that are to be performed immediately are performed. For example, the system may ensure that any computing processes that are non-flexibly-scheduled resources that are to be performed at a current time are completed and/or have sufficient resources available to be completed and that resources remain available after all such computing processes have been performed. In some implementations, the system performing the method 500 may ensure that all non-flexibly-scheduled computing processes requiring the particular type of resource have been performed prior to determining that there is an excess availability of the particular type of resource. In some implementations, the system performing the method 500 may clear the computing process queue of all computing processes that are to be performed at a current time and/or all computing processes that are to be performed as soon as possible, before determining that there is an excess availability of resources. For example, the system may determine that there is an excess availability of the resource of the particular type if all computing processes requiring the particular type of resource that are to be performed at the current time and/or that are to be performed as soon as possible have been performed and/or have been removed from the computing process queue.

In some instances, an excess availability of a resource of a particular type may be identified by the computing system by detecting that resources of the particular type have been added or otherwise been made available. For example, the computing system may detect, at the operation 508, that new computing resources have been added. By way of example, the new computing resources may be memory or processing resources. In some implementations, detecting an excess availability of a resource of a particular type based on the resource availability data may include detecting another computing process whose execution causes the excess availability of the resource of the particular type. For example, the another computing process may be a transfer or other operation providing an excess supply of a non-native resource. By way of example, computing process such as an incoming transfer may be initiated in non-native units and/or may use non-native resources and, to be completed, it may require a conversion to native units and/or use native resources. This may cause an excess supply of the non-native units or resources, allowing a computing process that requires such non-native units or resources for completion to be performed. For example, an outgoing transfer or other computing process may utilize the excess supply of the non-native units or resources.

In response to detecting an excess availability of the resource of the particular type, the computing system may, at an operation 510, identify a flexibly-scheduled computing process requiring the use of the resource of the particular type. The operation 510 may be performed directly in response to detecting the excess availability of the resource of the particular type at the operation 508. For example, no further input may be required in order to cause the operation 510 to be performed.

The identification of a flexibly-scheduled process at operation 510 may be performed using a variety of techniques. For example, in some implementations, identifying a flexibly-scheduled process may include identifying computing processes that are designated as having a variable time parameter while ignoring computing processes that are identified as having a rigid time parameter. That is, the computing system may, at the operation 510, distinguish between the types of computing processes configured at an iteration of the operation 502 (in which a flexibly-scheduled computing process is configured) from the types of computing processes configured at an iteration of the operation 504 (in which a non-flexibly-scheduled computing process is configured). The flexibly-scheduled computing processes have a variable time parameter while the non-flexibly-scheduled computing processes may have a rigid time parameter.

At the operation 510, the computing system may identify a computing process that requires use of the particular type of resource for which there is an excess availability, as detected at the operation 508. The computing system may identify the computing process using the computing process queue. The computing system may, at the operation 510, ignore computing processes that are in the computing process queue that do not require use of the particular resource.

In at least some implementations one or more of the flexibly-scheduled computing processes may be associated with a time parameter. The time parameter may, for example, be a time parameter defined or determined when the flexibly-scheduled computing process is configured, for example, at the operation 502. The time parameter may identify a last time at which the flexibly-scheduled computing process is to be performed. For example, the time-parameter may be a deadline such as a due date or time. This deadline may represent a latest time at which the computing process may be performed. The deadline may be defined based on user input received at an endpoint 110 and sent to the computing system at the operation 502.

As noted above, the time parameter may, additionally or alternatively, specify whether the timing is rigid or flexible. Where a computing process has a rigid time parameter, it may specify that the computing process is to be completed at a defined time, such as at a particular time. The defined time may be a current time. That is, at least some computing processes that have a rigid time parameter may be computing processes that are configured for completion as soon as possible; that is, immediately.

In at least some implementations and in at least some situations, the computing process queue may include multiple flexibly-scheduled computing processes and the computing system performing the method 500 may, at the operation 510, identify a computing process by selecting one or more of these computing processes. For example, the computing system may identify a highest priority one of the computing processes that require use of the resource of the particular type (i.e., the resource having an excess availability). In some implementations, at the operation 510, the computing system may identify a set of flexibly-scheduled computing processes requiring the use of the resource of the particular type. The computing system may then select one of the flexibly-scheduled computing processes from the identified set as the identified flexibly-scheduled computing process as the highest priority computing process in the set. This selection may be based on a proximity of a time parameter identifying a last time at which the flexibly scheduled computing process is to be performed to a current time. For example, the computing process that is due soonest may be selected.

The identification of a computing process at the operation 510 may be performed based on other criteria instead of or in addition to the criteria described above. For example, it may be that the identification or selection of a computing process is based on the amount of computing resources of the particular type that are required for completion of that computing process. For example, the computing system may only identify computing processes that require an amount of resources of the particular type that is less than or equal to the excess amount of the resources of the particular type available. Put differently, the computing system may ignore computing processes that require more resources of the particular type than are available.

After a flexibly-scheduled computing process is identified at the operation 510, the computing system may initiate the flexibly-scheduled computing process at operation 512 to consume at least a portion of the excess availability of the resource. Put differently, after a computing process that can use the excess availability of the resource is identified, it may be performed. As noted previously, this computing process may be of a variety of types. In some implementations, the computing process may be a process that requires processor resources and the processor may be used at the operation 512. In some instances, the computing process may require use of a communication system or subsystem and such a system or subsystem may be used at the operation 512. In some implementations, the computing process includes a database management operation and so at the operation 512 a database management operation may be performed. For example, any one or more of the database management operations recited herein or other such operations may be performed. For example, a value or other data may be updated. In some implementations, the computing process includes a transfer of at least a portion of the resource for which there was determined to be an excess supply and so a transfer may be performed at the operation 512. In at least some implementations, the transfer may use non-native units or resources. In at least some implementations, the operation 512 may be performed immediately after the operation 510 without requiring any input from a user between the operations 510 and 512. In some implementations, the operation 512 may include sending a message or instruction to another computing system, such as the second computing system 140 or the third-party computing system 160 to cause such computing systems to perform all or a portion of the computing process. By way of example, in some implementations, the instruction may instruct one or more of the computing systems to effect a transfer.

The operations 510 and 512 may be repeated until all excess resources of the particular type have been utilized or until the computing process queue includes no further computing processes that can be completed using the excess resources that are available.

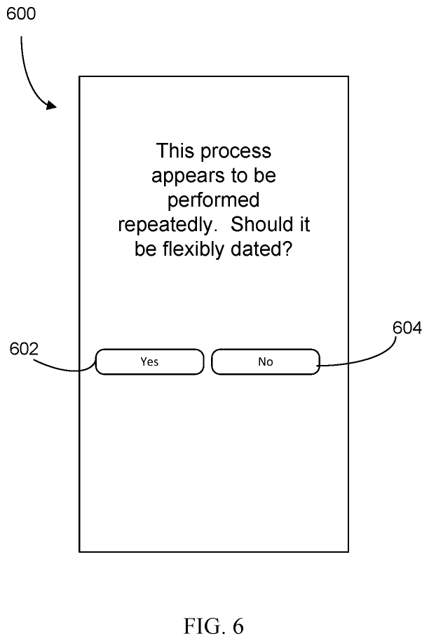

Reference will now be made to FIG. 6, which illustrates an example interface 600 that may be used to configure a computing process as either flexibly-scheduled or non-flexibly-scheduled. The interface 600 may be displayed on an endpoint 110, such as an endpoint 110 associated with a particular logical storage area, in response to a detected condition. The detected condition may be a condition detected by the computing system performing one or more of the methods 500, 900 described herein or by another computing system. For example, the condition may be detected when the computing system identifies recurring computing processes using a resource of a particular type and associated with a particular logical storage area. For example, in some implementations, the condition may be detected when the computing system identifies recurring computing processes using a particular non-native resource and associated with a particular logical storage area. Whether a computing process is recurring may be evaluated relative to a threshold. The threshold may be defined relative to a time period. For example, the threshold may represent a minimum average that is determined over a time period. By way of example, the threshold may require a process requiring a particular resource to be performed at least monthly for the computing process to be considered, by the computing system, to be recurring. Whether a computing process is recurring or not may be determined based on historical data such as historical computing process data.

The interface 600 includes a selectable option 602 to configure a computing process or any future computing processes utilizing a particular resource and/or associated with a particular logical storage area as flexibly-scheduled. The interface 600 may, in some implementations, include a selectable option 604 to configure the computing process or any future computing processes utilizing a particular resource and/or associated with a particular logical storage area as non-flexibly-scheduled.

The selectable options 602, 604 may be configured to, upon selection, cause the endpoint 110 to send data indicating the selection to the computing system, such as the first computing system 130, which may be the computing system performing the method 500.

The interface 600 may take other forms. For example, in some instances, the interface may provide an offer or enticement to configure a computing process as flexibly-scheduled. For example, the offer or enticement may be a resource-incentive offer. For example, the offer may be an offer to apply a particular input output modifier to computing processes that are configured as flexibly-scheduled that is not applied to computing processes that are configured as non-flexibly-scheduled. The input-output modifier, which may also be referred to as a modifier, may improve efficiency when the computing process is performed. Such improved efficiency may result in fewer resources being consumed when the computing process is performed. In one implementation, the resource-incentive offer may allow for the use of relatively better resources. For example, if the resource is a hashing system, then a faster hashing system may be used for flexibly-scheduled computing processes than is used for non-flexibly-scheduled computing processes. In another example, where the resource is a conversion system such as, for example, a codec server or an exchange server, then flexibly-scheduled computing processes may have computing processes performed in a manner that causes less originating resources and/or data to be lost. For example, conversions may be performed so that there is less loss. Less loss may be performed by one or more of: using an improved conversion algorithm or consuming less of the resources as a processing cost or “gas” required to perform the computing process.

In another example, the interface 600 may be displayed in response to another detected condition and the interface may be modified accordingly. For example, the interface 600 may be displayed when a new computing process is being defined by an endpoint 110. For example, the interface 600 may be displayed as part of a computing process definition interface and it may allow the endpoint 110 to define whether the newly-defined computing process is flexibly-scheduled or non-flexibly-scheduled.

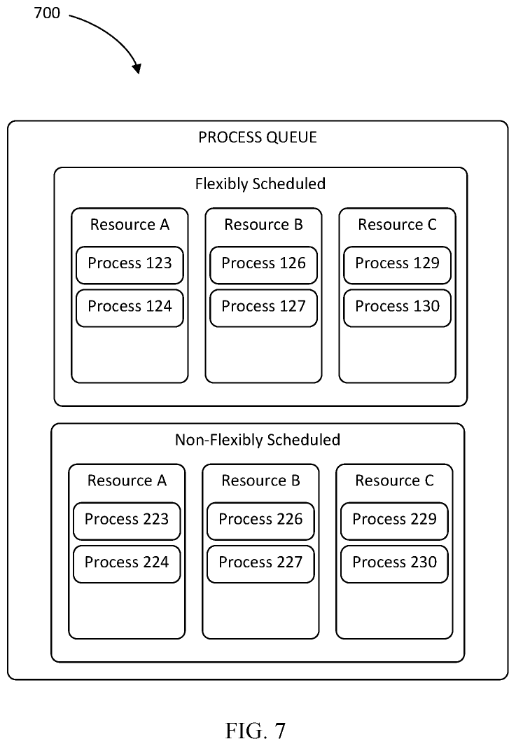

Reference will now be made to FIG. 7 which illustrates an example data structure that forms a computing process queue 700. The example computing process queue includes both flexibly-scheduled and non-flexibly-scheduled computing processes. In the example, the computing process queue 700 includes a flexibly-scheduled computing process queue and a non-flexibly-scheduled computing process queue. The computing processes in the queues are associated with resource types. For example, the computing processes in each of the queues may be organized or categorized by resource types. A computing process may be associated with a particular type of resource and this type of resource may be a resource that is required for completion of that computing process. In some instances, one or more computing process may require multiple resources for operation but may be considered by the system, for the purposes of categorization or organization, to be associated with one of those resources which is defined or determined to be scarcer than the other of those resources.

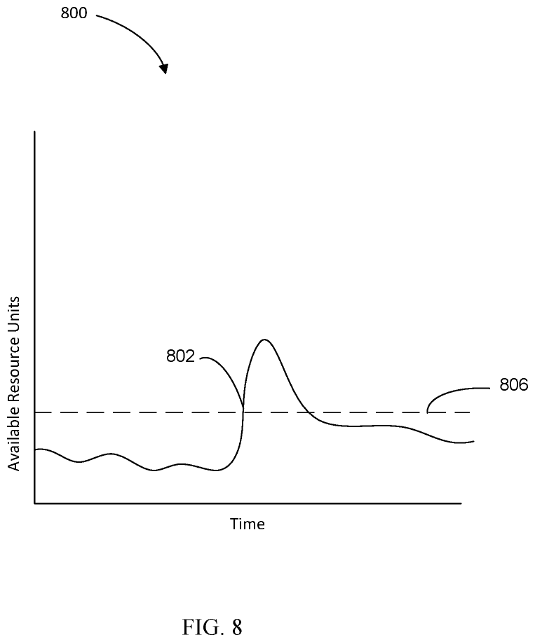

Reference will now be made to FIG. 8 which illustrates example resource availability data 800. The resource availability data 800 may be used at the operation 506 of the method 500. The resource availability data 800 illustrates an amount of available resource units for a particular type of resource. The example resource availability data 800 is shown over time. The resource availability data 800 shows a threshold 806. The threshold 806 may represent an average or typical level or resources. The threshold may be determined based on historical resource availability data.

The resource availability data 800 shows how the amount of resources transitions above the threshold 806 at a time 802. At this time, the excess availability of resources may be detected at the operation 508 of the method 500.

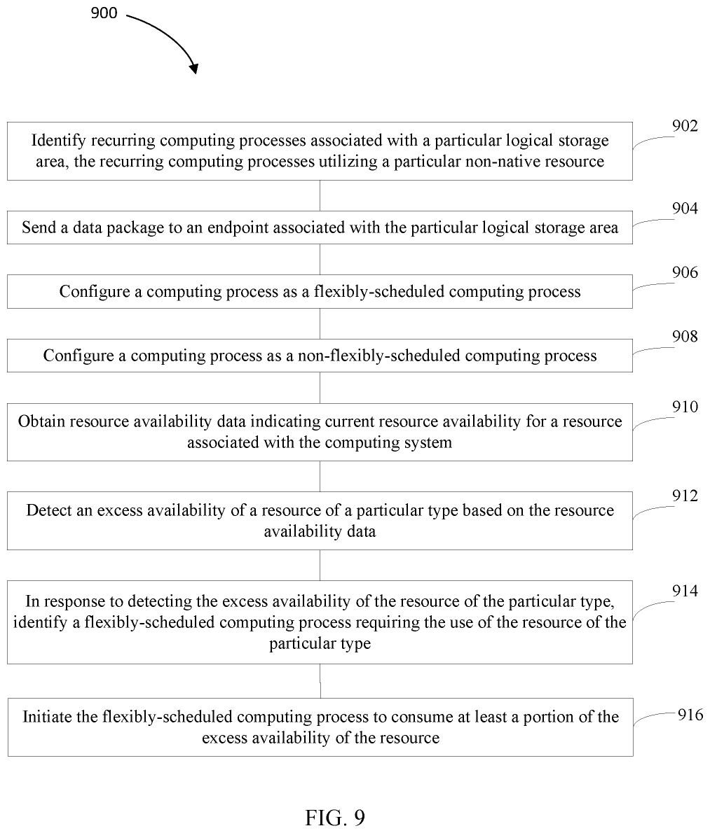

Reference will now be made to FIG. 9, which illustrates a flowchart of an example method 900. FIG. 9 shows operations performed by a computing system, such as the first computing system 130. For example, in at least some implementations, computer-executable instructions stored in memory associated with the computing system may configure the computing system to perform the operations of the method 900 or a portion thereof. By way of example, the computer-executable instructions may cause a processor associated with the computing system to perform the method 900 or a portion of the method 900.

The computing system performing the method 900 may cooperate with other computing systems using a communications module. The communications module may be or include a hardware communications module. By way of example, the first computing system 130 may communicate with one or more of a second computing system 140, and a endpoint 110 in order to perform the method 900 or a variation thereof.

The method 900 is a variation of the method 500 of FIG. 5 and it may include many operations in common with the method 500 of FIG. 5 and, for the sake of brevity and readability, the description of such operations will not be repeated at length.

First, at an operation 902, the computing system may identify recurring computing processes associated with a particular logical storage area. The computing system may, at the operation 902, identify recurring computing processes associated with a particular logical storage area utilizing a particular non-native resource. Whether a computing process is recurring may be evaluated relative to a threshold. The threshold may be defined relative to a time period. For example, the threshold may be an average. By way of example, the threshold may require a process requiring a particular resource to be performed at least monthly for the computing process to be considered, by the computing system, to be recurring. Whether a computing process is recurring may be determined as described above with reference to FIG. 6. For example, historical computing process data may be used to determine whether a computing process using a particular type of resource is recurring for a particular logical storage area.

Next, at an operation 904, the computing system may, in response to identifying the recurring computing processes utilizing the particular non-native resource, send a data package to an endpoint 110 associated with the particular logical storage area. The data package includes data to enable the endpoint to cause future computing processes involving the non-native resource and associated with the particular logical storage area to be designated as flexibly-scheduled by default. By way of example, the data package may configure the endpoint 110 to display or otherwise output the interface 600 or a variation thereof.

The data package that is sent from the computing system to the endpoint may indicate a modifier to be used for flexibly-scheduled computing processes that is not used for computing processes having a rigid time parameter.

The method 900 may include operations 906, 908, 910, 912, 914 and 916. The operations 906, 908, 910, 912, 914 and 916 may be the same or similar to the operations 502, 504, 506, 508, 510 and 512 of the method 500 of FIG. 5 respectively.

In at least some implementations, at the operation 916, when initiating the flexibly-scheduled computing process, the modifier may be used. The modifier may operate as described above with reference to FIG. 6. For example, the modifier may cause improve efficiency of operation. The modifier may, for example, cause fewer resources or fewer resource units to be consumed for flexibly-scheduled computing processes than are consumed for non-flexibly scheduled computing processes.

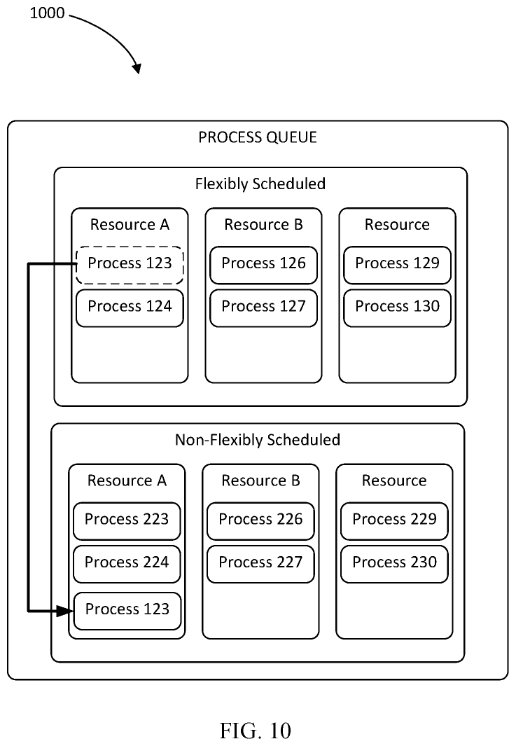

Reference will now be made to FIG. 10 which illustrates a further example computing process queue 1000. The computing process queue 1000 of FIG. 10 is similar to the computing process queue 700 of FIG. 7 but the example of FIG. 10 illustrates how a flexibly-scheduled computing process may be automatically reconfigured as a non-flexibly-scheduled computing process in response to detecting a defined condition. The computing system may re-categorize a flexibly-scheduled computing process as a non-flexibly-scheduled computing process in response to detecting a particular condition. The particular condition may be based on a time parameter associated with the flexibly-scheduled computing process. For example, the particular condition may be based on a due date or deadline defined for the flexibly-scheduled computing process. If the due date or deadline is determined to be within a defined proximity of the current date or time, then the condition may be determined to have been detected. By way of example, in an implementation, if the due date or deadline for a flexibly-scheduled computing process is a current date and/or time, then the flexibly-schedule computing process may be reconfigured by the computing system, such as the first computing system 130, to be a non-flexibly-scheduled computing process so that it may be performed more expediently and/or even if no excess resources are available. In the example of FIG. 10, a flexibly-scheduled computing process labelled “process 123” which uses a resource labelled “recourse A” is reconfigured as a non-flexibly-scheduled computing process.

The operations that re-configure a particular computing process that was initially configured as flexibly-scheduled so that such a computing process is, instead, configured as non-flexibly-scheduled, may be included in a method which may be performed by a computing system such as the first computing system 130. For example, such operations may be included in the method 500 of FIG. 5 and/or the method 900 of FIG. 9 or a variation thereof. A processor associated with the first computing system 130 may be configured with processor-executable instructions which cause one or more such operations to be performed. For example, the computing system may determine that a flexibly-scheduled computing process is to be reconfigured as a non-flexibly scheduled computing process based on a proximity to a due date or deadline. The computing system may, in response to this determination, reconfigure the flexibly-scheduled computing process as a non-flexibly-scheduled computing process. In at least some implementations, when a flexibly-scheduled computing process is reconfigured as a non-flexibly-scheduled computing process, any modifier that was to apply to the flexibly-scheduled computing process may remain in place. Such reconfigured computing processes may still be performed with the modifier in place.

Example embodiments of the present application are not limited to any particular operating system, system architecture, mobile device architecture, server computing system architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A computing system comprising:
a communications module;
a processor coupled with the communications module; and
a memory coupled to the processor and storing processor-executable instructions which, when executed by the processor, configure the computing system to:
obtain resource availability data indicating current resource availability for a resource associated with the computing system;
detect an excess availability of a resource of a particular type based on the resource availability data;
in response to detecting the excess availability of the resource of the particular type, identify a flexibly-scheduled computing process requiring use of the resource of the particular type; and
initiate the flexibly-scheduled computing process to consume at least a portion of the excess availability of the resource.

2. The computing system of claim 1, wherein identifying a flexibly-scheduled computing process includes identifying computing processes that are designated as having a variable time parameter while ignoring computing processes that are identified as having a rigid time parameter.

3. The computing system of claim 2, wherein the flexibly-scheduled computing process is associated with a time parameter identifying a last time at which the flexibly-scheduled computing process is to be performed and wherein a computing process that is identified as having a rigid time parameter is a computing process that is to be completed at a defined time.

4. The computing system of claim 3, wherein the defined time is a current time.

5. The computing system of claim 1, wherein the flexibly-scheduled computing process includes a database management operation.

6. The computing system of claim 1, wherein the flexibly-scheduled computing process includes a transfer of at least a portion of the resource.

7. The computing system of claim 1, wherein the instructions further configure the computing system to:
identify recurring computing processes associated with a particular logical storage area, the recurring computing processes utilizing a particular non-native resource; and
in response to identifying the recurring computing processes utilizing the particular non-native resource, send a data package to an endpoint associated with the particular logical storage area, the data package including data to enable the endpoint to cause future computing processes involving the non-native resource and associated with the particular logical storage area to be designated as flexibly-scheduled by default.

8. The computing system of claim 7, wherein the data package indicates a modifier to be used for flexibly-scheduled computing processes that is not used for computing processes having a rigid time parameter, and wherein initiating the flexibly-scheduled computing process includes using the modifier.

9. The computing system of claim 1, wherein identifying the flexibly-scheduled computing process includes:
identifying a set of flexibly-scheduled computing processes requiring the use of the resource of the particular type; and
selecting one of the flexibly-scheduled computing processes from the identified set as the identified flexibly-scheduled computing process based on a proximity of a time parameter identifying a last time at which the flexibly-scheduled computing process is to be performed to a current time.

10. The computing system of claim 1, wherein detecting an excess availability of a resource of a particular type based on the resource availability data includes:
detecting another computing process whose execution causes the excess availability of the resource of the particular type.

11. The computing system of claim 10, wherein the another computing process is a transfer providing an excess supply of a non-native resource.

12. A computer-implemented method comprising:
obtaining resource availability data indicating current resource availability for a resource associated with a computing system performing the method;
detecting an excess availability of a resource of a particular type based on the resource availability data;
in response to detecting the excess availability of the resource of the particular type, identifying a flexibly-scheduled computing process requiring the use of the resource of the particular type; and
initiating the flexibly-scheduled computing process to consume at least a portion of the excess availability of the resource.

13. The method of claim 12, wherein identifying a flexibly-scheduled computing process includes identifying computing processes that are designated as having a variable time parameter while ignoring computing processes that are identified as having a rigid time parameter.

14. The method of claim 12, wherein the flexibly-scheduled computing process is associated with a time parameter identifying a last time at which the flexibly-scheduled computing process is to be performed and wherein a computing process that is identified as having a rigid time parameter is a computing process that is to be completed at a defined time.

15. The method of claim 14, wherein the defined time is a current time.

16. The method of claim 12, wherein the flexibly-scheduled computing process includes a database management operation.

17. The method of claim 12, wherein the flexibly-scheduled computing process includes a transfer of at least a portion of the resource.

18. The method of claim 12, further comprising:
identifying recurring computing processes associated with a particular logical storage area, the recurring computing processes utilizing a particular non-native resource; and
in response to identifying the recurring computing processes utilizing the particular non-native resource, sending a data package to an endpoint associated with the particular logical storage area, the data package including data to enable the endpoint to cause future computing processes involving the non-native resource and associated with the particular logical storage area to be designated as flexibly-scheduled by default.

19. The method of claim 18, wherein the data package indicates a modifier to be used for flexibly-scheduled computing processes that is not used for computing processes having a rigid time parameter, and wherein initiating the flexibly-scheduled computing process includes using the modifier.

20. The method of claim 12, wherein identifying the flexibly-scheduled computing process includes:
identifying a set of flexibly-scheduled computing processes requiring the use of the resource of the particular type; and
selecting one of the flexibly-scheduled computing processes from the identified set as the identified flexibly-scheduled computing process based on a proximity of a time parameter identifying a last time at which the flexibly scheduled computing process is to be performed to a current time.
